(19) United States
(12) Patent Application Publication
(10) Pub. No.: US 2023/0129963 A1
(43) Pub. Date: Apr. 27, 2023

(54) INSPECTION APPARATUS AND INFORMATION PROCESSING SYSTEM

(71) Applicant: TAMRON CO., LTD., Saitama (JP)

(72) Inventor: Kyuki SHIBUYA, Saitama (JP)

(73) Assignee: TAMRON CO., LTD., Saitama (JP)

(21) Appl. No.: 17/944,656

(22) Filed: Sep. 14, 2022

(30) Foreign Application Priority Data
Oct. 25, 2021 (JP) 2021-173900

(51) Int. Cl. G01N 21/88; G01N 21/64

(52) U.S. Cl. CPC G01N 21/88; G01N 21/64

(57) ABSTRACT

An inspection apparatus includes a first optical system configured to irradiate a measurement object with ultraviolet light, a second optical system configured to detect, with a detector, at least one of the specific polarizations and fluorescence of 200 to 400 nm emitted from the measurement object, and a calculation unit that acquires information on an aromatic amino acid and a residue thereof in the irradiated portion according to a detection value of light detected by the detector.

### CROSS-REFERENCE TO RELATED APPLICATIONS

This application is based on and claims the benefit of priority from Japanese Patent Application No. 2021-173900, filed on Oct. 25, 2021, the entire contents of which are incorporated herein by reference.

### BACKGROUND OF THE INVENTION

### Technical Field

The present invention relates to an inspection apparatus and an information processing system.

### Related Art

In a field of public health or livestock industry, early detection of risk factors causing food poisoning or infection is required. In particular, organic substances such as proteins still remaining after cleaning are likely to be a hotbed for breeding of microorganisms.

As a technique for optically detecting the presence or absence of an organic substance on the surface of an object, there is known a technique for irradiating the surface of a metal object, which is a measurement object, with excitation light such as ultraviolet light and detecting fluorescence of visible light on the surface of the object to detect the presence or absence of oil or fat on the surface of the object (see, for example, JP 2013-205203 A).

In addition, as a technique for detecting an organic substance by detecting fluorescence, there is known a technique for irradiating a plurality of types of fluorescent markers associated with a living tissue with excitation light and determining a state of the living tissue depending on which fluorescent marker generates fluorescence (see, for example, JP 2017-189626 A).

Furthermore, as a technique for detecting an organic substance by detection of fluorescence, there is known a technique for irradiating particles derived from a living body in a fluid with excitation light that excites tryptophan and tyrosine, detecting fluorescence derived from the particles by detecting light having a specific wavelength or more among detection target light including generated fluorescence, and measuring a concentration of the particles in a sample (see, for example, JP 2021-032867 A).

Furthermore, amino acids and proteins that are secondary structures thereof are known to exhibit circularly polarized light absorption and emission specific to the ultraviolet region (see, for example, Y. Le Pan, “Detection and characterization of biological and other organic-carbon aerosol particles in atmosphere using fluorescence”, Journal of Quantitative Spectroscopy & Radiative Transfer, p. 12-35, 2015).

### SUMMARY OF THE INVENTION

However, in the conventional technique, when a measurement object carrying a detection object such as a protein emits fluorescence under the same conditions as those of the detection object, it may be difficult to distinguish between fluorescence emitted by the detection object and fluorescence emitted by the measurement object carrying the detection object.

An object of one aspect of the present invention is to provide a technique capable of detecting a detection object by fluorescence and polarized light even when a measurement object that emits fluorescence carries fluorescence having a spectrum superimposed with fluorescence derived from an aromatic amino acid.

In order to solve the above problem, an inspection apparatus according to an aspect of the present invention includes: a first optical system configured to irradiate a measurement object with ultraviolet light; a second optical system configured to detect, with a detector, one or more types of light selected from a group consisting of fluorescence of circularly polarized light having a wavelength of 200 nm or more and 400 nm or less, fluorescence of non-circularly polarized light, and reflected light of circularly polarized light emitted from an irradiated portion of the measurement object irradiated with the ultraviolet light; and a calculation unit configured to acquire information on an aromatic amino acid and a residue thereof in the irradiated portion according to a detection value of light detected by the detector.

In addition, in order to solve the above problem, an information processing system according to an aspect of the present invention includes: an irradiation control unit configured to irradiate a measurement object with ultraviolet light; a detection control unit configured to detect, with a detector, one or more types of light selected from a group consisting of fluorescence of circularly polarized light having a wavelength of 200 nm or more and 400 nm or less, fluorescence of non-circularly polarized light, and reflected light of circularly polarized light emitted from an irradiated portion of the measurement object irradiated with ultraviolet light; a calculation unit configured to acquire information on an aromatic amino acid and a residue thereof in the irradiated portion according to a detection value of light detected by the detector; and a notification control unit configured to notify a user of information on the aromatic amino acid and a residue thereof in the irradiated portion acquired by the calculation unit.

According to one aspect of the present invention, even when a measurement object that emits fluorescence carries a detection object derived from an aromatic amino acid, the detection object can be detected by fluorescence and polarized light.

### BRIEF DESCRIPTION OF THE DRAWINGS

FIG. 1 is a diagram schematically illustrating a functional configuration of an inspection apparatus according to an embodiment of the present invention;

FIG. 2 is a view schematically illustrating a first example of a first optical system in the embodiment of the present invention;

FIG. 3 is a view schematically illustrating a second example of the first optical system in the embodiment of the present invention;

FIG. 4 is a view schematically illustrating a third example of the first optical system in the embodiment of the present invention;

FIG. 5 is a view schematically illustrating a first example of a mode of uniformizing the intensity of ultraviolet light in the first optical system of the embodiment of the present invention;

FIG. 6 is a view schematically illustrating a second example of a mode of uniformizing the intensity of ultraviolet light in the first optical system of the embodiment of the present invention;

FIG. 7 is a view schematically illustrating a first example of an irradiation mode of a measurement object in the first optical system of the embodiment of the present invention;

FIG. 8 is a view schematically illustrating a second example of the irradiation mode of the measurement object in the first optical system of the embodiment of the present invention;

FIG. 9 is a view schematically illustrating a third example of the irradiation mode of the measurement object in the first optical system of the embodiment of the present invention;

FIG. 10 is a view schematically illustrating a first example of a light receiving mode of a detection target light in a second optical system of the embodiment of the present invention;

FIG. 11 is a view schematically illustrating a second example of the light receiving mode of the detection target light in the second optical system of the embodiment of the present invention;

FIG. 12 is a view schematically illustrating a third example of the light receiving mode of the detection target light in the second optical system of the embodiment of the present invention;

FIG. 13 is a view schematically illustrating a fourth example of the light receiving mode of the detection target light in the second optical system of the embodiment of the present invention;

FIG. 14 is a view schematically illustrating a first example of a mode for converting a wavelength of detection target light according to an embodiment of the present invention;

FIG. 15 is a view schematically illustrating a second example of the mode for converting a wavelength of detection target light according to an embodiment of the present invention;

FIG. 16 is a view schematically illustrating a first example of structured illumination for distance confirmation by visible light in an embodiment of the present invention;

FIG. 17 is a view schematically illustrating a second example of structured illumination for distance confirmation by visible light in an embodiment of the present invention; and

FIG. 18 is a block diagram schematically illustrating an example of a functional configuration of an information processing system according to an embodiment of the present invention.

### DESCRIPTION OF THE EMBODIMENTS

At a site where living tissues are handled, residues of living tissues such as proteins remaining after washing may cause adverse effects by microorganisms such as food poisoning or infection. At a site where living organisms and living tissues are handled, it is usually required to be clean in terms of hygiene, and a technique for inspecting the presence or absence of the residues is required.

Examples of residues include water, lipids, and proteins, wherein the proteins include amino acids that all organisms have. Therefore, grasping the presence or absence of an amino acid in the measurement object can be an indicator for evaluating the presence of an organism and the breeding risk. Among amino acids, aromatic amino acids, i.e., tryptophan, tyrosine, and phenylalanine, are known to emit ultraviolet fluorescence upon excitation of ultraviolet light, and can be quantitatively measured. Therefore, by quantitatively measuring the fluorescence intensity of the ultraviolet fluorescence, non-contact and immediate measurement can be realized. Furthermore, it is known that the aromatic amino acid exhibits characteristic circularly polarized light absorption and circularly polarized light emission in the ultraviolet region. It is also possible to selectively detect the aromatic amino acid by measuring the absorption and emission characteristics of the circularly polarized light of the aromatic amino acid. Hereinafter, an embodiment of the present invention will be described in detail.

[Inspection Apparatus]

[Overall Configuration]

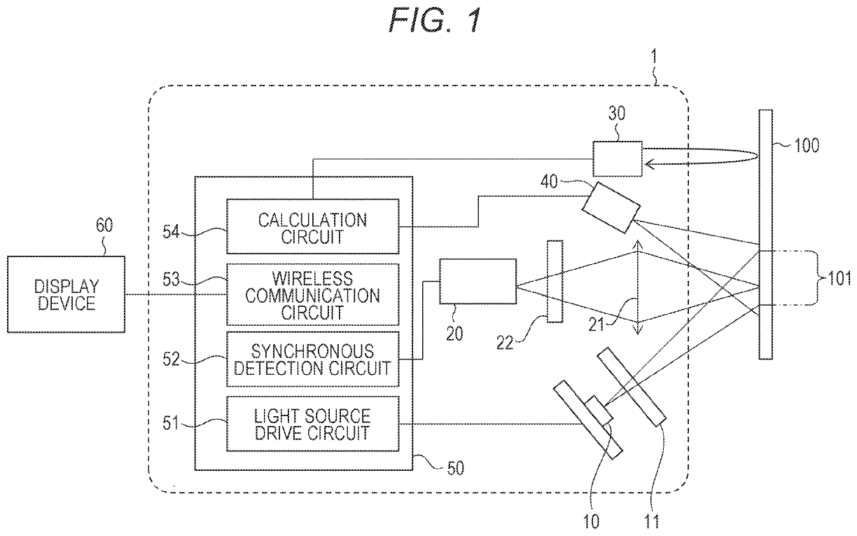

The inspection apparatus according to an embodiment of the present invention is, for example, in a form of a hand-held type, a mobile body mounted type, or a non-stationary type, that is, a portable form. FIG. 1 is a diagram schematically illustrating a functional configuration of an inspection apparatus according to an embodiment of the present invention.

As illustrated in FIG. 1, the inspection apparatus 1 includes an ultraviolet (UV) light source 10, a detector 20, a distance measurement device 30, an illumination device 40, and a control device 50. The control device 50 is connected to a display device 60, and the inspection apparatus 1 is configured to be able to display inspection information on the display device 60.

[Inspection Target]

An object to be inspected by the inspection apparatus 1 is a measurement object 100. The measurement object 100 is, for example, a work table of a kitchen in a food factory or a gauge for breeding in a livestock farm such as a poultry farm. An object to be measured (detection object) is the above-described aromatic amino acid and a residue thereof, and examples thereof include an aromatic amino acid itself and a protein which is a secondary structure thereof. In the present embodiment, an embodiment of an inspection apparatus will be described by taking a case as an example where a protein as a detection object is attached to the surface of a solid measurement object 100.

In the description of the embodiments, “fluorescence” and “circularly polarized light” mean “fluorescence in the ultraviolet region” and “circularly polarized light in the ultraviolet region” unless otherwise specified. In addition, in the description of the embodiment, “to” means a range above and below including the numbers at both ends.

[First Optical System]

The first optical system is an optical system for irradiating the measurement object 100 with ultraviolet light. In the embodiment of the present invention, the wavelength of “ultraviolet light” can be appropriately determined within a range in which an aromatic amino acid can be selectively detected. From the viewpoint of selective detection of aromatic amino acids, the wavelength of ultraviolet light to be irradiated is preferably 200 to 400 nm, more preferably 200 to 320 nm, and still more preferably 200 to 300 nm.

The first optical system includes a light source that outputs ultraviolet light, and may appropriately include an optical element such as an optical filter as necessary. In the inspection apparatus 1 of FIG. 1, an UV light source 10 and an optical filter 11 constitute the first optical system. In the first optical system, the optical filter 11 is disposed between the UV light source 10 and the measurement object 100. The optical filter 11 is an optical filter for wavelength selection, and is, for example, a long pass filter or a band pass filter. In the optical filter 11, a polarizing filter for polarization selection can be disposed, and the polarizing filter is, for example, a photoelastic modulator.

The first optical system may be any of a refractive optical system, a reflection optical system, a phase optical system, and a diffractive optical system as long as the measurement object 100 can be irradiated with ultraviolet light.

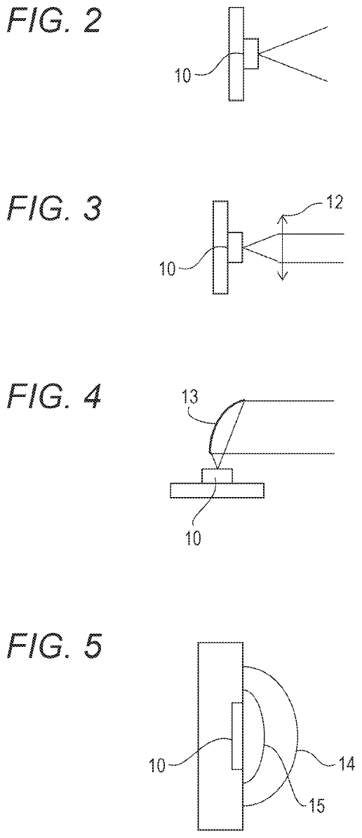

FIGS. 2 to 4 schematically illustrate examples of the first optical system according to the embodiment of the present invention. As illustrated in FIG. 2, the first optical system may include only the UV light source 10 without the above-described optical filter. Alternatively, as illustrated in FIG. 3, the first optical system may further include a projection lens 12 in addition to the optical filter described above. Alternatively, as illustrated in FIG. 4, the first optical system may further include a reflective optical element 13 that reflects the ultraviolet light from the TV light source 10 toward the measurement object 100, in addition to the optical filter described above.

In particular, in the ultraviolet region, transmission loss due to the material of the lens may become a problem. In addition, since the fluorescence emitted from the lens is superimposed on the signal of the fluorescence in the detector 20 as an erroneous signal, accurate measurement may be difficult. Therefore, it is preferable to use, in the first optical system, an optical element made of a material having high ultraviolet transmissivity and generating less fluorescence by ultraviolet light from the viewpoint of suppressing the occurrence of the above problems. Examples of a material having high ultraviolet transmissivity and generating less fluorescence by ultraviolet light include quartz and a silicone-based resin.

(Light Source)

The UV light source 10 may be configured to generate ultraviolet light having a desired wavelength, for example, ultraviolet light having a wavelength of 200 to 400 nm. There are two absorption wavelength bands around 225 nm and around 280 nm for the aromatic amino acid and a residue thereof. The UV light source 10 is preferably configured to generate light having a wavelength (for example, 222 nm) corresponding to the former band from the viewpoint of reducing the influence of generated UV on a living body.

Examples of the UV light source 10 include a device using discharge, such as a xenon lamp, a light emitting diode (LED), a laser, a laser diode (LD), and a wavelength conversion light source. From the viewpoint of cost reduction of the inspection apparatus 1, the UV light source 10 is preferably a light emitting diode.

It is preferable that the first optical system can irradiate the measurement object with ultraviolet light of which intensity is modulated from the viewpoint of enhancing detection accuracy in the detector. This point will be described in detail later. Such a first optical system can be realized by using the UV light source 10 capable of modulating the intensity of ultraviolet light. The modulation of the intensity in the UV light source 10 can be realized by a method of directly modulating the light source driving voltage or current, a method of using an electro-optical effect, or a method of using a mechanical mechanism such as a chopper and a polygon mirror. The frequency in the modulation of the UV light source 10 may be, for example, 100 Hz to 10 MHz, and the irradiation intensity and the duty ratio may be arbitrarily adjusted.

The first optical system preferably further includes a light diffusion layer that diffuses ultraviolet light from the viewpoint of making the distribution of the emission intensity of ultraviolet light uniform. The light diffusion layer may be at any position in the first optical system, but from the above viewpoint, the light diffusion layer is preferably disposed adjacent to the UV light source 10 on the measurement object 100 side.

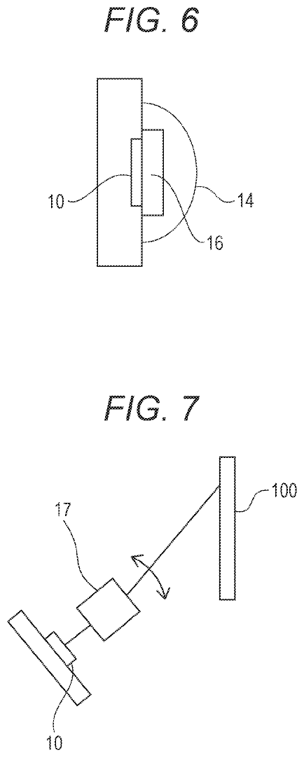

FIGS. 5 and 6 schematically illustrate examples of a mode of uniformizing the intensity of ultraviolet light in the first optical system according to the embodiment of the present invention. Since many light sources have a finite light emission area, the distribution of the light emission intensity may be non-uniform. Therefore, from the viewpoint of realizing uniform light emission intensity, a diffusion plate is disposed at the subsequent stage of the light source (an irradiated portion 101 side). When the distance from the light source to the diffusion plate increases, the diffusion plate serves as a secondary light emitting source, and light from the light source is diffused in a wide range in the diffusion plate, leading to a loss of light. Therefore, the light diffusion layer is preferably disposed immediately after the light source.

For example, as illustrated in FIG. 5, such a light diffusion layer may be a light diffusion portion 15 formed in a gap between an illumination lens 14 covering the UV light source 10 and the UV light source 10. The light diffusion portion 15 is configured such that a liquid containing a scattering medium is sealed in the gap. As a result, the spatial intensity unevenness of light is reduced by the light scattering due to the Brownian motion of the scattering medium, and a distribution of a spatial intensity of light can be made more uniform. As a result, when the first optical system includes the above configuration, it is easier to control luminous flux by the lens in the subsequent stage. As the liquid, an insulating liquid can be used.

Homogenization of the distribution of the spatial intensity of light can be adjusted by a thickness of the light diffusion portion 15 in an optical axis direction in accordance with a luminance distribution of the light source. By optimizing the thickness, the distribution of the spatial intensity of light can be made more uniform.

Furthermore, for example, as illustrated in FIG. 6, the light diffusion layer may be a diffusion plate 16 arranged so as to be sealed in a gap between the illumination lens 14 and the UV light source 10. In addition, plates having spatially different transmittance distributions may be arranged in the diffusion plate 16, for example, an apodizing filter can be used.

When the UV light source 10 is a light source having high temporal coherence such as a laser or a laser diode, the spatial coherence of the light source is also often high. Therefore, a speckle pattern may be generated in ultraviolet light. Disposing the light diffusion layer in the first optical system is preferable from the viewpoint of reducing a spatiotemporal coherence of the light source, suppressing the generation of the speckle pattern, and changing the speckle pattern spatiotemporally.

Furthermore, by disposing the light diffusion portion 15 adjacent to the UV light source 10, the heat of the UV light source 10 can be effectively used. That is, the temperature of the light diffusion portion 15 can be increased by the heat generated by the UV light source 10, and the thermal motion (Brownian motion) of the scattering medium is further activated. As a result, particles of the scattering medium are suppressed from being locally stagnant in the liquid, and ultraviolet light having a more uniform spatial intensity distribution can be constantly generated.

The light diffusion layer may further include a fluorescence generating agent. The fluorescence generating agent may be a component that emits fluorescence in a visible light region by ultraviolet light of the UV light source 10, may be a liquid or a scattering medium in the light diffusion portion 15, or may be a dispersoid dispersed in the diffusion plate 16.

Since the light diffusion layer contains the fluorescence generating agent, the measurement object 100 can be irradiated with fluorescence coaxially with ultraviolet light. For example, by irradiating the measurement object 100 with visible fluorescence, a user can visually recognize a site where the measurement object 100 is irradiated with ultraviolet light. By providing the liquid or the scattering medium of the light diffusion layer (the light diffusion portion 15) with the fluorescence emission ability in this manner, it is possible to further reduce the unevenness of the spatial intensity of the ultraviolet light and to coaxially generate the visible light indicating the irradiation position of the ultraviolet light.

In addition, since the light diffusion layer contains the fluorescence generating agent, multi-wavelength ultraviolet light also becomes possible. In the case of detecting the fluorescence of the measurement object, by further disposing an optical filter having a different wavelength band and a detector corresponding thereto in a second optical system, measurement with multi-wavelength ultraviolet light including the fluorescence becomes possible. In this case, since all ultraviolet light is synchronized, the identification of the corresponding fluorescence depends on the optical filter.

The multi-wavelength ultraviolet light can also be realized by preparing a plurality of light sources having different emission wavelengths. In this case, multi-channel synchronous detection may be performed asynchronously for each detection target light by ultraviolet light having different wavelengths.

(Irradiation Mode)

An irradiation mode of the ultraviolet light on the measurement object 100 in the first optical system can be various forms. FIGS. 7 to 9 schematically illustrate examples of the irradiation mode of the measurement object in the first optical system according to the embodiment of the present invention.

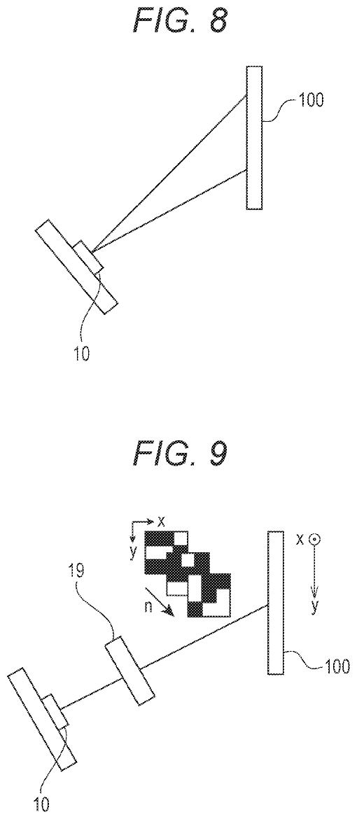

As illustrated in FIG. 7, the ultraviolet light irradiation mode may be point irradiation or line irradiation, or may be surface irradiation as illustrated in FIG. 8. The first optical system may irradiate the surface of the measurement object 100 by scanning with ultraviolet light by point irradiation, line irradiation, or surface irradiation. Scanning with ultraviolet light can be realized by arranging a mechanical element such as a polygon mirror 17 in an optical path of ultraviolet light, for example, as illustrated in FIG. 7.

The first optical system may irradiate the measurement object 100 with ultraviolet light by structured illumination. The structured illumination of ultraviolet light by the first optical system is also referred to as “structured illumination of ultraviolet light”. As illustrated in FIG. 9, the irradiation of the measurement object 100 by the structured illumination of the ultraviolet light can be realized as irradiation in a pattern of known density by arranging a spatial light modulator 19 in the optical path of the ultraviolet light.

According to scanning with ultraviolet light or irradiation with structured illumination of ultraviolet light, it is possible to visualize a spatial distribution of detection target light (at least one of fluorescence of circularly polarized light, fluorescence of non-circularly polarized light, and reflected light of circularly polarized light) from the measurement object 100 as described in detail later. For example, the spatial intensity distribution of the detection target light is detected as time-series data by scanning with point irradiation or line irradiation. By analyzing the time-series data, it becomes possible to distinguish between background light in the measurement object 100 and detection light (fluorescence of circularly polarized light, fluorescence of non-circularly polarized light, and reflected light of circularly polarized light) derived from the aromatic amino acid, and further, it becomes possible to acquire the spatial distribution of the intensity of the detection light.

The structured illumination of the ultraviolet light can be formed on the surface of the measurement object 100 by various techniques such as a MEMS mirror, a galvanometer mirror, a digital mirror device, a projector system using a liquid crystal, a light emitter having an image display capability, a system of arranging and sequentially projecting an arbitrary mask pattern on a rotating disc, an arrayed light source, and an interference fringe.

Furthermore, in the case of obliquely illuminating the surface of the measurement object 100, the first optical system may include an optical system that compensates for geometric distortion of structured illumination of ultraviolet light due to the direction of illumination. In this case, for example, by using Scheimpflug principle, it is possible to secure image formation of the structured illumination of the ultraviolet light on the measurement object 100. Furthermore, the first optical system may form structured illumination of ultraviolet light imaged on the surface of the measurement object 100 according to a measurement value of the distance measurement device 30.

(Other Optical Elements)

The first optical system may appropriately include a wavelength filter such as the band pass filter and the long pass filter described above. The first optical system may further include a polarization modulator.

[Second Optical System]

In the embodiment of the present invention, the second optical system is an optical system for detecting one or more types of light selected from the group consisting of fluorescence of circularly polarized light having a wavelength of 200 to 400 nm, fluorescence of non-circularly polarized light, and reflected light of circularly polarized light emitted from an irradiated portion of a measurement object irradiated with ultraviolet light by a detector. In inspection apparatus 1 of FIG. 1, the second optical system includes a detector 20, a condenser lens 21, and an optical filter 22. The condenser lens 21 and the optical filter 22 are disposed between the measurement object 100 and the detector 20. The optical filter 22 is, for example, a long pass filter. In the embodiment of the present invention, in the second optical system, the condensing optical system can be configured by an arbitrary combination as necessary within a range in which the effect of the present embodiment can be obtained.

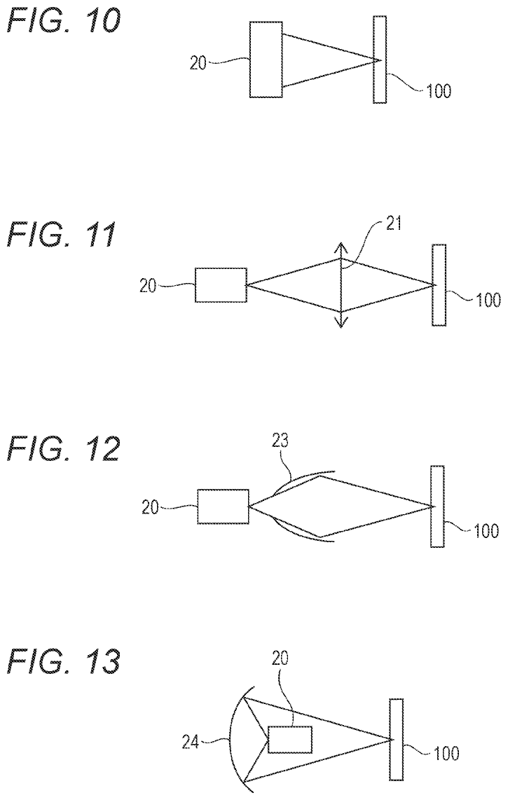

FIGS. 10 to 13 schematically illustrate examples of a light receiving mode of the detection target light in the second optical system according to the embodiment of the present invention. As illustrated in FIG. 10, the second optical system may include only the detector 20, or may further include the condenser lens 21 as illustrated in FIG. 11.

Furthermore, as illustrated in FIGS. 12 and 13, the second optical system may further include reflective optical elements 23 and 24. The reflective optical element 23 is a mirror or a dichroic mirror, and a reflection surface thereof has a non-planar shape, more specifically, has a concave curved surface with respect to the measurement object 100. The reflective optical element 23 receives light from the measurement object 100, reflects the light to be focused toward the detector 20, and transmits light of a desired wavelength (for example, ultraviolet fluorescence by an aromatic amino acid).

The reflective optical element 24 is a mirror and is disposed on the side opposite to the measurement object 100 with respect to the detector 20. The reflective optical element 24 has a concave curved surface with respect to the measurement object 100 and the detector 20, receives light from the measurement object 100, and reflects the light to be focused toward the detector 20.

It is preferable that the second optical system includes the reflective optical element from the viewpoint of enhancing the incident efficiency from the measurement object 100 to the detector 20.

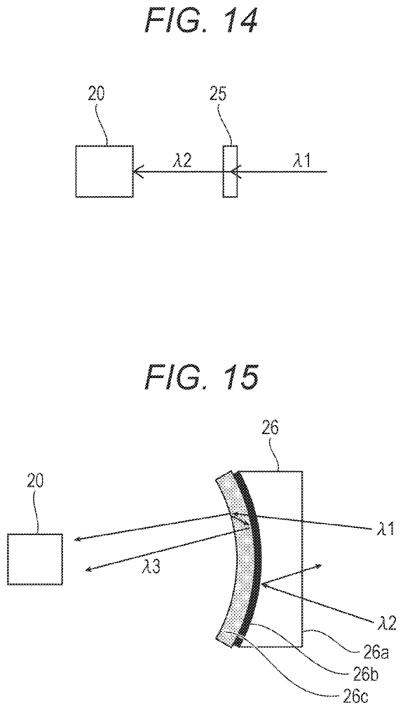

The second optical system may further include a wavelength conversion optical element. FIGS. 14 and 15 schematically illustrate an example of a mode for converting the wavelength of the detection target light according to the embodiment of the present invention. For example, as illustrated in FIG. 14, the second optical system may include a wavelength conversion optical element 25. The wavelength conversion optical element 25 is an optical element having a layer containing particles having wavelength conversion capability such as quantum dots. In FIG. 14, both λ1 and λ2 represent wavelengths of light from the measurement object 100, and λ2 is longer than λ1. In the second optical system including the wavelength conversion optical element 25, a detector having sensitivity to visible light can be used as the detector 20.

For example, as illustrated in FIG. 15, the second optical system may include a wavelength conversion optical element 26. The wavelength conversion optical element 26 includes a dielectric multilayer film 26b and a wavelength conversion layer 26c on a concave curved surface of an ultraviolet light transmitting element 26a. In FIG. 15, λ1 to λ3 each represent a wavelength of light from the measurement object 100 and background light, and λ3 is longer than λ1.

Since the second optical system includes the wavelength conversion optical element 26, it is possible to detect only ultraviolet light having a desired wavelength. The wavelength conversion optical element 26 transmits only ultraviolet light directed from the measurement object 100 to the detector 20, and then converts the wavelength of the ultraviolet light into a long wavelength. Since the wavelength conversion optical element 26 has a concave curved surface facing the detector 20, it is possible to control a reflection direction of the light reflected by the dielectric multilayer film 26b toward the measurement object 100. In addition, it is possible to further increase the incidence efficiency of the ultraviolet light after wavelength conversion on the detector 20.

In addition, the second optical system may include a light modulation element and a polarization element in order to detect fluorescence of circularly polarized light or reflected light of circularly polarized light. As will be described in detail later, it is preferable that the second optical system is configured to be able to detect the fluorescence of circularly polarized light or the reflected light of circularly polarized light from the viewpoint of making it possible to identify the presence or absence of the aromatic amino acid and the residue thereof even when it is difficult to separate the fluorescence of the background from the fluorescence derived from the aromatic amino acid.

(Detector)

The detector 20 is a device capable of detecting fluorescence of circularly polarized light in one or more wavelength ranges within a wavelength range of 200 to 400 nm, fluorescence of non-circularly polarized light, and reflected light of circularly polarized light, and is a device used, for example, for measurement of light intensity of emission and left- and right-handed circularly polarized light absorption rate in the wavelength range. The detector 20 may be any device that detects ultraviolet light having a wavelength in the range of 200 to 400 nm emitted by the irradiated portion 101 that has received ultraviolet light from the UV light source 10. The detector 20 may be a device that detects ultraviolet light or a device that detects visible light of a specific wavelength after wavelength conversion.

When the detector 20 is a detector sensitive only to ultraviolet light (for example, a detector having a SiC photodiode), substantially only desired ultraviolet fluorescence can be detected, and a dynamic range of the detector 20 and a measurement circuit can be more effectively used. In addition, an optical density (OD value) of the optical filter in the second optical system can be relaxed.

When the detector 20 is a detector (for example, silicon photomultiplier (SiPM), multi-pixel photon counter (MPPC), and photomultiplier tube (PMT)) having a light receiving area of 1 mm² or more, it is possible to sufficiently detect light from the measurement object without configuring the second optical system as a condensing optical system. Therefore, it is possible to simplify the configuration of the second optical system, which is suitable from the viewpoint of realizing miniaturization of the inspection apparatus.

The photometry in the detector 20 may be an analog method or a digital sampling method (digital method) such as a photon counting method.

[Distance Measurement Device]

The distance measurement device 30 is a device for measuring a distance to a measurement object by an ultrasonic wave or an electromagnetic wave. The distance measurement device 30 measures, for example, a distance to a surface of the measurement object 100 irradiated with ultraviolet light in a non-contact manner at an arbitrary timing. The distance measurement device 30 may be disposed at any position of the inspection apparatus 1 within a range where a distance from an emission surface of the UV light source 10 to the surface of the measurement object 100 can be measured. By including the distance measurement device 30, it is possible to compensate for the intensity of light (fluorescence of circularly polarized light, fluorescence of non-circularly polarized light, or reflected light of circularly polarized light) detected by the detector 20, which will be described in detail later. Therefore, it is preferable from the viewpoint of enhancing the detection accuracy when the distance between the inspection apparatus 1 and the measurement object 100 is not uniform.

[Illumination Device]

The illumination device 40 is a device for forming structured illumination for distance confirmation by irradiating the surface of the measurement object 100 with visible light. The illumination device 40 can illuminate structured illumination for visible distance confirmation having a focal position in an arbitrary illumination space. Therefore, it is possible to cause the user of the inspection apparatus 1 to visually recognize information of measurement distance.

In the case of obliquely illuminating the surface of the measurement object 100, similarly to the structured illumination of the ultraviolet light in the first optical system, the illumination device 40 may include an optical system that compensates for the geometric distortion of the structured illumination for distance confirmation depending on the direction of illumination. For example, the illumination device 40 may ensure the image formation of structured illumination for distance confirmation on the measurement object 100 by using the Scheimpflug principle. Furthermore, the illumination device 40 may form structured illumination for distance confirmation that forms an image on the surface of the measurement object 100 according to the measurement value of the distance measurement device 30.

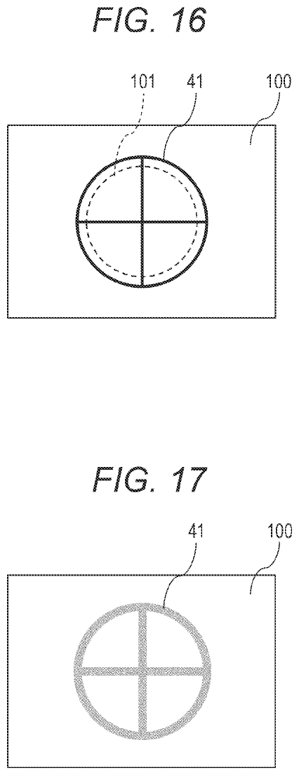

FIGS. 16 and 17 schematically illustrate examples of structured illumination for distance confirmation by visible light in an embodiment of the present invention. As illustrated in FIG. 16, the illumination device 40 forms structured illumination 41, which is structured illumination for distance confirmation by visible light, on the surface of measurement object 100. The structured illumination 41 has a shape of a circle and two straight lines (cross shape) representing a diameter of the circle and orthogonal to each other. On the surface of the measurement object 100, the irradiation position of the illumination device 40 is related to the irradiation position by the first optical system. When the irradiation position of the ultraviolet light by the first optical system on the surface of the measurement object 100 is the irradiated portion 101, the center of the circle of the structured illumination 41 is located at the center of the irradiated portion 101, and the circle of the structured illumination 41 is located so as to surround the irradiated portion 101. By irradiating the measurement object with visible light structured illumination having an arbitrary image forming position as auxiliary light serving as an indicator of the appropriate distance, it is possible to cause the user to visually recognize the appropriate distance.

The illumination device 40 may alternatively form structured illumination 41 at a constant focal position. For example, as shown in FIG. 17, when the focal position of structured illumination 41 moves away from the surface of measurement object 100, structured illumination 41 becomes thinner and its contour becomes blurred. Therefore, the user can visually recognize the portion irradiated with the ultraviolet light by the structured illumination 41, and can confirm that the distance between the inspection apparatus 1 and the measurement object 100 is deviated from an appropriate distance.

[Display Device]

The display device 60 is a device for displaying a detection result of the detector 20. The display device 60 displays information on aromatic amino acids and residues thereof in the irradiated portion 101 acquired by a calculation unit described later as numerical values or image information. Here, the “information on aromatic amino acids and residues thereof” is information on the presence or absence of aromatic amino acids and residues thereof and information on the amount of aromatic amino acids and residues thereof. The former can be obtained, for example, by determining a detection value with reference to a threshold value. The latter can be obtained, for example, by determining a detection value with reference to a calibration relationship obtained in advance.

The information is transmitted from the control device 50 to the display device 60 by wired or wireless communication. The display device 60 is a form of a notification device for notifying a user of information on aromatic amino acids and residues thereof. In the embodiment of the present invention, instead of the display device 60, a voice guidance device capable of notifying the user that the information on the aromatic amino acid and the residue thereof has been appropriately acquired by voice or transmission sound may be adopted as the notification device.

[Control Device]

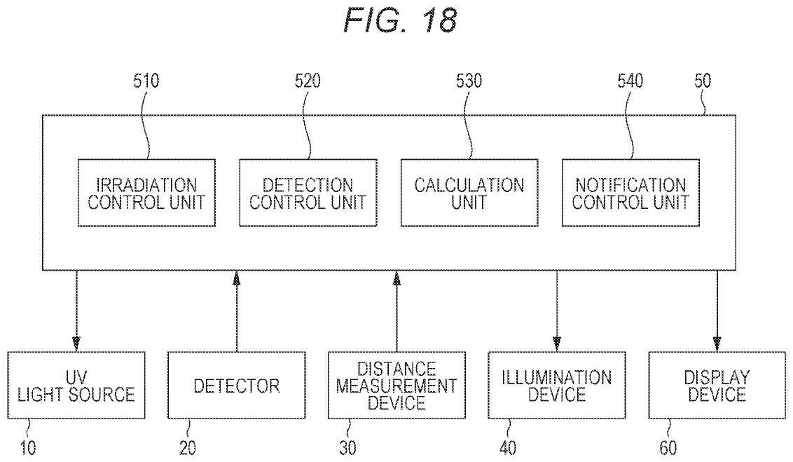

The control device 50 controls operation of light irradiation and detection, and notification of a detection result to the user. The control device 50 can be configured by various electronic circuits. The electronic circuit in the control device 50 can be appropriately selected within a range in which the information processing function required for the control device 50 can be realized. In FIG. 1, as an example of such an electronic circuit group, a light source drive circuit 51, a synchronous detection circuit 52, a wireless communication circuit 53, and a calculation circuit 54 are illustrated. In addition, the control device 50 may appropriately include various electronic circuits such as an amplifier circuit, a frequency filter circuit, a reference signal generation circuit, and an AD conversion circuit. A functional configuration related to the information processing of the control device 50 is illustrated in FIG. 18, for example.

[Information Processing System]

FIG. 18 is a block diagram schematically illustrating 2a an example of a functional configuration of an information processing system according to an embodiment of the present invention. As illustrated in FIG. 18, the control device 50 includes an irradiation control unit 510, a detection control unit 520, a calculation unit 530, and a notification control unit 540. These functional configurations are realized by the above-described electronic circuit.

The irradiation control unit 510 performs control to irradiate the measurement object with ultraviolet light (ultraviolet rays) having a wavelength of 200 to 300 nm. The irradiation control unit 510 controls, for example, on/off of the UV light source, intensity of ultraviolet light, and in a case where the surface of the measurement object is scanned with modulated ultraviolet light, scanning of ultraviolet light.

The detection control unit 520 performs control for causing a detector to detect at least one of fluorescence of circularly polarized light having a wavelength of 200 to 400 nm (that is, in the ultraviolet region), fluorescence of non-circularly polarized light, or reflected light of circularly polarized light emitted from an irradiated portion of the measurement object irradiated with ultraviolet light. The detection control unit 520 controls, for example, timing of light detection by the detector 20, setting of a light detection mode in the detector 20, and the like.

The notification control unit 540 performs control for notifying the user of the information on the aromatic amino acid and a residue thereof in the irradiated portion acquired by the calculation unit. For example, the notification control unit 540 causes the information to be output in a form corresponding to a device for notification. When the information is image data, an image corresponding to the image data is displayed on the display device 60. When the information is voice data, a voice corresponding to the voice data is output from a speaker.

The calculation unit 530 acquires information on the aromatic amino acid and the residue thereof in the irradiated portion according to the detection value of at least one of fluorescence of circularly polarized light, fluorescence of non-circularly polarized light, and reflected light of circularly polarized light by the detector 20. For example, the calculation unit 530 calculates one or more characteristics selected from a group consisting of absorption of circularly polarized light having a wavelength of 200 to 320 nm derived from a secondary structure of a protein, absorption of circularly polarized light having a wavelength of 240 to 320 nm derived from a side chain of an amino acid, and a difference in intensity of left- and right-handed circularly polarized light emission in these circularly polarized light according to detection values of fluorescence of circularly polarized light and reflected light of circularly polarized light by a detector, and acquires information on an aromatic amino acid and a residue thereof in an irradiated portion.

The calculation unit 530 selectively detects desired light information from the detection value from the detector 20. For selective detection of the light information, a synchronous detection method can be adopted. In adoption of the synchronous detection method, various devices or configurations suitable for the synchronous detection method can be appropriately adopted. Examples of such devices or configurations include lock-in amplifier, boxcar integrator, and gate system. In this manner, the calculation unit 530 may demodulate the detection value of the light detected by the detector 20 by synchronous detection.

The calculation method in the calculation unit 530 may be an analog method or a digital method. In a case where synchronous detection is performed, if an analog method is adopted, it is possible to realize cost reduction of the synchronous detection circuit. If a digital method is adopted, it is possible to substantially remove influence of bias voltage and voltage drift from the output value (detection result) from the detector 20.

When the detection object is present on a metal plate, only autofluorescence of the detection object can be selectively detected. However, when the detection object exists in a measurement object that emits autofluorescence, for example, a resin plate, the autofluorescence of the resin is superimposed on the fluorescence of the detection object, and it may be difficult to separate detection results of these fluorescences by the detector 20 according to a difference between these fluorescences. In such a case, detecting the polarization characteristics of reflected light and light emission such as autofluorescence emitted from the detection object and scattered light generated from the detection object is helpful for separating components derived from fluorescence of the detection object from the detection result.

At a wavelength of 200 to 320 nm, there is absorption of circularly polarized light derived from a secondary structure of the protein. In addition, at a wavelength of 240 to 320 nm, there is absorption of circularly polarized light derived from a side chain of an amino acid, and there is also a difference in left- and right-handed circularly polarized light emission. By detecting these differences in absorption or emission, it is possible to identify the presence or absence of the detection object even in a case where separation from fluorescence from objects other than the detection object is difficult.

On the other hand, there is also a case where highly sensitive measurement of residual amino acids is not required. In such a case, the influence of the autofluorescence of the measurement object may be negligible. For example, in a case where such highly sensitive measurement is not required, an arbitrary threshold value may be set to the measurement value. By setting such a threshold value, it is possible to sufficiently extract the detection result of the fluorescence of the detection object from the detection result including the fluorescence of the measurement object.

The calculation unit 530 may acquire time-series data of light detected by the detector 20 according to the detection value of the light and acquire the information of spatial distribution of the light according to the time-series data. The time-series data can be acquired from, for example, the above-described scanning of ultraviolet light and the detection result thereof by the detector. The time-series data includes information of a spatial fluorescence intensity distribution. Therefore, by analyzing the time-series data, it is possible to distinguish between the fluorescence (background light) emitted from the measurement object and the fluorescence emitted from the detection object, and it is possible to acquire information on the spatial distribution of the fluorescence intensity.

In addition, the calculation unit 530 may acquire time-series data of the light according to the detection value of the light detected by the detector 20, and may acquire information of the spatial distribution of the light by taking a form of single pixel imaging in which an image is reconstructed by mathematically processing the pattern of the structured illumination of the ultraviolet light described above and the time-series data.

The image data reconstructed by the mathematical processing can be acquired from the above-described structured illumination of the ultraviolet light and the detection result by the detector 20. The measurement object 100 is irradiated with a plurality of different structured illuminations of ultraviolet light, fluorescence intensity for each structured illumination of ultraviolet light is recorded as time-series data, and a known structured illumination pattern of ultraviolet light and the time-series data are mathematically processed. This makes it possible to acquire information on the spatial distribution of the fluorescence intensity on the surface of the measurement object 100. Furthermore, in such information processing, a synchronous detection method can be used together.

In the case of using single pixel imaging, fading of fluorescence during measurement results in a decrease in the measurement value, which can be an error in the measurement. In this case, the calculation unit 530 preferably performs, for example, the following arithmetic processing from the viewpoint of compensating for the influence of fading. That is, it is preferable to perform processing of acquiring n pieces of I(n), where the number of the structured illumination of the ultraviolet light is n, and the light intensity value or the number of photons for each photometry is I(n), correcting slope of approximation straight line of the time-series data of n points, correcting the approximation curve, and weighting each measurement value. As an example of the slope correction of the approximation straight line, first, a linear approximation formula y(n)=a×n+b is obtained for the time-series data. Then, a×n is added to or subtracted from I(n) to correct the time-series data. Thereafter, the image is reconstructed using the corrected time-series data.

In the present embodiment, the calculation unit 530 corrects the detection value of the light detected by the detector 20 according to the measurement value of the distance by the distance measurement device 30. The correction of the detection value can be performed, for example, by referring to a known relationship (correlation formula, map, and the like) between the measurement value of the distance by the distance measurement device 30 and attenuation rate of the detection value (for example, the number of photons) in the detector. With this correction, it is possible to substantially eliminate the influence of the distance to the measurement object 100 from the measured value of the detector 20, and it is possible to further improve the detection accuracy.

On the other hand, in the measurement in a state of greatly deviating from the appropriate distance, it is difficult to compensate the detection value of the light detected by the detector 20 based on the measurement value of the distance by the distance measurement device 30. In a case where the user operates the inspection apparatus 1, it is preferable to cause the user to visually, audibly, or tactilely recognize the appropriate distance in the measurement by the inspection apparatus 1 from the viewpoint of enhancing the detection accuracy. Such indication of the appropriate distance can be performed, for example, by formation of structured illumination of visible light (structured illumination for distance confirmation) by the illumination device 40 described above.

[Implementation Example by Software]

The function of the control device 50 (hereinafter, referred to as a “device”) can be realized by a program for causing a computer to function as the device, and which is a program for causing a computer to function as each control block of the device (particularly, each unit included in the control device 50).

In this case, the device includes a computer having at least one control device (for example, a processor) and at least one storage device (for example, a memory) as hardware for executing the program. By executing the program by the control device and the storage device, the functions described in the above embodiments are realized.

The program may be recorded not temporarily but in one or a plurality of computer-readable recording media. The recording medium may or may not be included in the device. In the latter case, the program may be provided to the device via any wired or wireless transmission medium.

In addition, some or all of the functions of the control blocks can be realized by a logic circuit. For example, an integrated circuit in which a logic circuit functioning as each control block is formed is also included in the scope of the present invention. In addition, for example, the functions of the control blocks can be realized by a quantum computer.

In addition, each processing described in the above embodiments and the like may be executed by an artificial intelligence (AI). In this case, the AI may operate in the control device, or may operate in another device (for example, an edge computer, a cloud server, or the like).

[Other Preferable Configurations]

The inspection apparatus in the embodiments of the present invention may further include a wireless communication device. According to this configuration, data remote transmission to a mobile device or the like and remote control from the mobile device can be performed. In this case, the control device preferably further includes a communication control unit that controls signal processing of output signal and bidirectional wireless communication.

The inspection apparatus preferably further includes a power source from the viewpoint of ease of handling. A low-noise power supply is preferably employed as the power source. The low-noise power supply has a configuration in which a linear regulator is connected to each of positive and negative voltage sides extracted using a midpoint potential of a battery as a ground. In general, it is desirable that the measurement circuit has low noise, and thus it is desirable that the power source of the inspection apparatus is a low-noise power supply.

In a circuit for measurement, generally, both positive and negative power sources are required in many cases. In a small-sized inspection apparatus, generally, a battery, a switching power supply, or a voltage conversion circuit is used for each of both power sources. The midpoint potential of the battery is unstable, and the switching power supply and the voltage conversion circuit have problems of generation of switching noise, heat generation due to heat loss, and power consumption. In the above-described low-noise power supply, a linear regulator is connected to each side of positive and negative voltages extracted using a midpoint potential of a battery as a ground. Therefore, a compact and low-noise power supply can be realized.

The inspection apparatus may further include a device (such as an integrating sphere or a multipath cell) that can gain an action length of the excitation light with the measurement object in the cell as the measurement object or the second optical system. In this case, it is suitable for measuring samples in a gaseous or liquid form.

In addition, the inspection apparatus may further include a device that outputs a local sound pressure by ultrasonic waves or a radiation pressure by light toward a fluid measurement object. By having such an output device, for example, a particulate measurement object in the fluid is aggregated or held in the fluid, and the measurement object in the fluid can be more suitably measured.

In addition, the control device of the inspection apparatus may further include a function capable of arbitrarily adjusting the timing of irradiation with ultraviolet light and detection by the detector. For example, when a lifetime of the fluorescence of the detection object is longer than a lifetime of the fluorescence of a portion other than the detection object, an arbitrary delay time is set to the timing of the irradiation of the ultraviolet light from the light source and the detection by the detector. Then, detection by the detector is performed at timing when the intensity of fluorescence of the detection object exceeds the fluorescence (background light) of the portion other than the detection object. As described above, it is preferable to appropriately set the timing of the irradiation of the ultraviolet light from the light source and the detection by the detector from the viewpoint of enhancing the detection accuracy.

Furthermore, in the inspection apparatus, the calculation unit may calculate information of a detection value by the detector with reference to information of known background light, and acquire information of aromatic amino acids and residues thereof in the irradiated portion according to the calculated information. The information of the known background light can be acquired, for example, by measuring autofluorescence of the measurement object in advance by an inspection apparatus. In this case, the calculation unit calculates a difference between the detection value of the detection object and the detection value of the known autofluorescence, and acquires information on the aromatic amino acid and a residue thereof in the irradiated portion according to the difference. This configuration is effective from the viewpoint of further reducing the influence of background light (autofluorescence of the measurement object).

In addition to the distance measurement device, the inspection apparatus may further include a measurement distance notification device for notifying the user of information on the measurement distance based on the measurement value of the distance by the distance measurement device. The measurement distance notification device may transmit a signal to cause the user to recognize the optimum distance for measurement. Examples of transmitted signals include sound, vibration, and visible light. More specifically, the measurement distance notification device may cause the user to recognize the optimum distance for measurement by notification by voice, a pattern or volume of voice, flashing of ultraviolet light of a light source or an illumination device, or the like.

In addition, in a case where the inspection apparatus includes two or more distance measurement devices, the calculation unit can acquire the incident angle of the ultraviolet light from the light source to the measurement object according to the information of the measurement value of the distance by the distance measurement device. Then, the calculation unit may perform feedback processing on the measurement position of the inspection apparatus according to the information of the incident angle acquired in this manner. The control device may display the result of the feedback processing on the display device, or may notify the user of the result of the feedback processing by the measurement distance notification device.

In addition, in a case where the inspection apparatus includes the above-described distance measurement device or illumination device, one or both of the first optical system and the second optical system may further have a focus function. This configuration is even more suitable from the viewpoint of enabling stable measurement regardless of the measurement distance.

In a case where the detection value of the detector is acquired as the time-series data, the time-series data can be acquired as long as the surface of the measurement object moves relative to the light source. Therefore, the inspection apparatus may scan the surface of the measurement object by moving the entire inspection apparatus while irradiating the ultraviolet light from the light source, regardless of the scanning of the light source. The time-series data in this case may be acquired during the movement of the inspection apparatus along the surface of the measurement object, may be acquired only for a specific time from the start of scanning by the inspection apparatus, or may be acquired for a period specified by the user during scanning by the inspection apparatus. In this case, the control device 50 may further include an input unit for receiving a specified instruction from the user. The input unit may have a functional configuration for receiving wireless communication or a functional configuration for receiving a signal from an input device such as a keyboard or a touch panel.

[Applications]

The inspection apparatus according to the embodiment of the present invention can be suitably employed for portable use in various situations where the presence or absence of a biological sample is required to be detected. The inspection apparatus 1 is not limited to a portable form, and may be a form that can be mounted on a mobile body, or may be a fixed form that is fixedly arranged with respect to a measurement object. In addition, the inspection apparatus can be used to detect a detection object attached to or carried on a measurement object that emits autofluorescence, as well as a measurement object that does not emit autofluorescence.

The inspection apparatus can be, for example, a handheld bacterial visualization device for a surgical procedure. In the case of using in such a hand-held form, the distance between the inspection apparatus and the measurement object is not always constant, and thus, there is a possibility that the number of photons incident on the detector greatly fluctuates according to the distance and is estimated to be low. In this case, the relative intensity distribution of fluorescence in one image can be recognized, but in the case of using time-series data, the detection accuracy may vary. Having the function of compensating the fluorescence intensity from the distance information as described above is effective from the viewpoint of securing the quantitativity of the measurement value, and is useful not only for a handheld inspection apparatus but also for an inspection apparatus in a form of being mounted on a moving body such as a drone or a radio-controlled car.

According to such a configuration, it is possible to detect contamination derived from a living tissue more easily and sufficiently with high accuracy in a site related to the living tissue such as medical care, livestock industry, and food processing industry. This is expected to secure a healthy life and improve work efficiency for people involved in the site, and is expected to contribute to the achievement of the sustainable development goals (SDGs).

[Main Effects]

Examples of the residue of a biological sample include water, lipids, and proteins. Among these, proteins include amino acids (phenylalanine, tyrosine, tryptophan) possessed by all organisms. Therefore, grasping the presence or absence of the remaining amino acid can be an indicator for evaluating the presence of an organism and the breeding risk.

As an existing test method for detecting a residue of such a biological sample, there is a method for detecting adenosine n-phosphate (n=1, 2, 3) using a fluorescent reagent (ATP method and A3 method). In the ATP method and the A3 method, a decrease in fluorescence emission intensity due to an inhibitor (salt, ethanol, sodium hypochlorite, benzalkonium chloride, and the like) is likely to occur due to the characteristics of the fluorescent reagent. In addition, since the sample is collected by wiping, not only local sampling inspection but also the total amount of the measurement object to be sampled tends to change depending on the wiping method (area and rubbing strength). As described above, the existing inspection method mainly has a problem of quantitativity.

The amino acid is known to emit fluorescence upon excitation of ultraviolet light, and can be quantitatively measured. Therefore, non-contact and in-situ measurement can be realized by quantitatively measuring the fluorescence intensity. For example, JP 2013-205203 A and JP 2017-189626 A described above describe that fluorescence in visible range of amino acids due to irradiation with ultraviolet light is detected. However, in a case where fluorescence in the visible range is detected, it is necessary to perform detection under a condition such as a dark room that other visible light has substantially no effect. In addition, since fluorescence in the visible range is detected, it is difficult to distinguish between fluorescence emitted by an amino acid as a detection object and fluorescence emitted by a measurement object carrying the amino acid. Furthermore, in general, precise fluorescence measurement is performed using a fluorescence microscope or a fluorescence spectrophotometer under light shielding. Therefore, it is difficult to use the biological sample at a site where the biological sample is handled, and an operation distance (distance between the detection object and the inspection apparatus) becomes 1 cm or less, or the visual field becomes narrow.

On the other hand, an inspection apparatus according to an embodiment of the present invention is configured to emit ultraviolet light, detect one or more types of light selected from the group consisting of fluorescence of circularly polarized light in the ultraviolet region due to aromatic amino acids and residues thereof, fluorescence of non-circularly polarized light, and reflected light of circularly polarized light, and acquire information on aromatic amino acids and residues thereof in an irradiated portion according to a detection value of light detected by a detector. The inspection apparatus can acquire quantitative information of aromatic amino acids and residues thereof instantly while being simple. For this reason, it is configured to be small and easy to transport, and it is possible to measure elements of risk factors (aromatic amino acids and residues thereof) in a wide range in real time in a non-contact manner. Therefore, a measurement in a wide range, which is difficult with the conventional wiping type, is realized. This makes it possible to grasp risk factors in public health at an early stage and take prompt measures.

In the embodiment of the present invention, in a case where autofluorescence having a wavelength of 200 nm or more and 400 nm or less is not generated in the irradiated portion, the inspection apparatus can acquire information on aromatic amino acids and residues thereof in the irradiated portion by detecting fluorescence of non-circularly polarized light with a detector. The “case where the autofluorescence is not generated in the irradiated portion” includes a case where the measurement object does not generate the autofluorescence, a case where an adhesive matter attached to the irradiated portion in the measuring object does not generate the autofluorescence, and the like.

Further, in the embodiment of the present invention, in a case where autofluorescence having a wavelength of 200 nm or more and 400 nm or less is generated in the irradiated portion, the inspection apparatus can acquire information on aromatic amino acids and residues thereof in the irradiated portion by detecting fluorescence of circularly polarized light with a detector. By detecting circularly polarized fluorescence, circularly polarized light emission specific to aromatic amino acids is detected.

Alternatively, in the embodiment of the present invention, in a case where autofluorescence having a wavelength of 200 nm or more and 400 nm or less is generated in the irradiated portion, the inspection apparatus can acquire information on aromatic amino acids and residues thereof in the irradiated portion by detecting reflected light of circularly polarized light with a detector. By detecting reflected light of circularly polarized light, absorption of circularly polarized light derived from a secondary structure of a protein or derived from a side chain of an aromatic amino acid is detected.

The light detected by the detector may be appropriately determined according to the use of the inspection apparatus or the accuracy and convenience required by the inspection apparatus. For example, from the viewpoint of versatility, the inspection apparatus may be configured to be able to detect all of the three types of light. Alternatively, the inspection apparatus may be configured to be able to detect only fluorescence of non-circularly or circularly polarized light as long as the inspection apparatus is used for simple inspection. Alternatively, the inspection apparatus may be configured to be able to detect only reflected light of circularly polarized light as long as the inspection apparatus is used for simple inspection limited to proteins. Alternatively, the inspection apparatus may be configured to be able to detect at least fluorescence of circularly polarized light and reflected light of circularly polarized light as long as the inspection apparatus is used for quantitative inspection of aromatic amino acids and residues thereof.

In addition, since the measuring device of the embodiment of the present invention can measure autofluorescence and circularly polarized light in the ultraviolet region of aromatic amino acids and the like, it is possible to selectively detect aromatic amino acids, and it is possible to realize visualization by converting the aromatic amino acids into image data. In the present embodiment, the wavelength of light detected by the detector is included in the range of 200 to 400 nm. In the wavelength range, the contribution of solar radiation on the ground is small. Therefore, it is possible to effectively use a dynamic range of the detector and a circuit provided at the subsequent stage thereof when used outdoors. In addition, by using a detector having sensitivity only to ultraviolet light, it is also possible to relax the optical density (OD value) of a filter that can be arranged at the preceding stage.

In an embodiment of the present invention, the calculation unit may calculate one or more characteristics selected from the group consisting of absorption of circularly polarized light having a wavelength of 200 to 320 nm derived from a secondary structure of a protein, absorption of circularly polarized light having a wavelength of 240 to 320 nm derived from a side chain of an amino acid, and a difference in emission intensity of left- and right-handed circularly polarized light in these circularly polarized light according to detection values of light detected by the detector, and acquire information on an aromatic amino acid and a residue thereof in the irradiated portion. By simultaneously measuring the circularly polarized light absorption and the circularly polarized light emission, the autofluorescence of the detection object can be detected even when the measurement object emits autofluorescence.

Further, in the embodiment of the present invention, the inspection apparatus may further include a distance measurement device for measuring a distance to a measurement object by an ultrasonic wave or an electromagnetic wave, and the calculation unit may correct a detection value of light detected by the detector according to a measurement value of the distance by the distance measurement device. As described above, in the embodiment of the present invention, it is preferable to have a function of compensating the fluorescence intensity from the distance information from the viewpoint of securing the quantitativeness of the measurement value. This configuration is useful for a handheld inspection apparatus, and is also useful for an inspection apparatus mounted on a moving body.

In addition, in the embodiment of the present invention, it is possible to make the user recognize an appropriate measurement distance by arranging a separate visible light source. That is, in the embodiment of the present invention, the inspection apparatus may further include an illumination device for irradiating the surface of the measurement object with visible light to form structured illumination for distance recognition. This configuration is particularly suitable for a handheld inspection apparatus from the viewpoint of enhancing output stability. By further having such a function related to distance recognition, stable measurement can be performed even in an environment where the distance between the inspection apparatus and the measurement object is not stable.

Also, in embodiments of the present invention, lock-in fluorescence imaging by employing excitation light scanning or single pixel imaging is possible. That is, in the embodiment of the present invention, the time-series data is acquired from the detection value of the light detected by the detector when the surface of the measurement object is scanned with the ultraviolet light, and the information of the spatial distribution of the light can be acquired accordingly. In this case, it is possible to acquire information on the spatial distribution of the detection light by the aromatic amino acid or the like.

Alternatively, in an embodiment of the present invention, the first optical system irradiates the measurement object with ultraviolet light by structured illumination of ultraviolet light, and the calculation unit acquires time-series data of a detection value of light detected by the detector, and mathematically processes a pattern of the structured illumination of ultraviolet light and the time-series data to take a form of single pixel imaging for reconstructing an image, thereby acquiring information of a spatial distribution of the light.

In embodiments of the present invention, lock-in imaging is enabled by adopting a form of ultraviolet light scanning or single pixel imaging as described above. These configurations are suitable from the viewpoint of eliminating disturbance.

In addition, when single pixel imaging is employed, the measurement time can be shortened, and in addition, the influence of fading can be compensated. The shortening of the measurement time can be realized by using compressed sensing, deep learning, or AI analysis in the form of single pixel imaging, and is advantageous from the viewpoint of shortening the measurement time as compared with scanning type measurement.

In the embodiment of the present invention, the synchronous detection method is adopted, which is advantageous for improving SN ratio. That is, in the embodiment of the present invention, the first optical system may irradiate the measurement object with the ultraviolet light in which the intensity is modulated, and the calculation unit may demodulate the detection value of the light detected by the detector by the synchronous detection.

The modulation of the intensity of the ultraviolet light also allows the inactivation of the risk factors that can be brought about by the ultraviolet light. Ultraviolet light adopted for the ultraviolet light is considered to be harmful to an organism, and risk management is performed by irradiation intensity in JIS C7550. The measurement device according to the embodiment of the present invention has a highly sensitive detection characteristic. Therefore, it becomes possible to emit weaker ultraviolet light, and it becomes possible to treat as a low risk group or risk release in the risk management. In addition, since it is not necessary to use a separate inert device after the measurement, it is advantageous from the viewpoint of achieving work efficiency and prevention of inactive treatment leakage.

In the embodiment of the present invention, it is possible to remove disturbance by the synchronous detection method and combine a high-efficiency condensing system optimally designed as necessary. The synchronous detection method can be realized by employing, for example, a lock-in amplifier. As a result, in the embodiment of the present invention, for example, it is possible to efficiently detect a weak fluorescence signal even in a state where the operation distance is 1 cm or more, and it is also possible to secure a wide visual field.

Therefore, the present invention can be applied to a handheld form or a use mounted on a moving body, and it is possible to detect fluorescence of a target with sufficiently high accuracy even when a distance to the measurement object is required. Therefore, the influence of the light asynchronous with the excitation light (indoor illumination light, sunlight, and the like) is substantially eliminated from the detection value, which is advantageous from the viewpoint of realizing measurement that is not limited to the use environment. As described above, the above configuration enables more stable measurement at outdoors in which many disturbances exist or in a form of being mounted on a mobile body.

In the embodiment of the present invention, adopting the band pass filter in the second optical system is effective for selectively detecting only necessary fluorescence.

### SUMMARY

As is apparent from the above description, an inspection apparatus (1) according to an embodiment of the present invention includes: a first optical system configured to irradiate a measurement object (100) with ultraviolet light; a second optical system configured to detect, with a detector (20), one or more types of light selected from a group consisting of fluorescence of circularly polarized light having a wavelength of 200 nm or more and 400 nm or less, fluorescence of non-circularly polarized light, and reflected light of circularly polarized light emitted from an irradiated portion (101) of the measurement object irradiated with the ultraviolet light; and a calculation unit (530) configured to acquire information on an aromatic amino acid and a residue thereof in the irradiated portion according to a detection value of light detected by the detector.

Furthermore, an information processing system according to an embodiment of the present invention includes: an irradiation control unit (510) configured to irradiate a measurement object with ultraviolet light; a detection control unit (520) configured to detect, with a detector, one or more types of light selected from a group consisting of fluorescence of circularly polarized light having a wavelength of 200 nm or more and 400 nm or less, fluorescence of non-circularly polarized light, and reflected light of circularly polarized light emitted from an irradiated portion of the measurement object irradiated with ultraviolet light; a calculation unit configured to acquire information on an aromatic amino acid and a residue thereof in the irradiated portion according to a detection value of light detected by the detector; and a notification control unit (540) configured to notify a user of information on the aromatic amino acid and a residue thereof in the irradiated portion acquired by the calculation unit.

Therefore, in the embodiment of the present invention, even when the measurement object that emits fluorescence carries the detection object derived from an aromatic amino acid, the detection object can be detected by fluorescence and polarized light.

In the embodiment of the present invention, the calculation unit may calculate one or more characteristics selected from a group consisting of absorption of circularly polarized light having a wavelength of 200 nm or more and 320 nm derived from a secondary structure of a protein or less, absorption of circularly polarized light having a wavelength of 240 nm or more and 320 nm or less derived from a side chain of an amino acid, and a difference in emission intensity of left- and right-handed circularly polarized light in these circularly polarized light according to detection values of fluorescence of circularly polarized light and reflected light of circularly polarized light detected by the detector, and acquire information on the aromatic amino acid and a residue thereof in the irradiated portion. This configuration is even more effective from the viewpoint of detecting the autofluorescence of the detection object carried by the measurement object that emits autofluorescence.

In the embodiment of the present invention, the measurement device may further include a distance measurement device (30) for measuring a distance to the measurement object by an ultrasonic wave or an electromagnetic wave, in which the calculation unit may correct a detection value of light detected by the detector according to a measurement value of the distance by the distance measurement device. This configuration is even more effective from the viewpoint of securing the quantitativity of the measurement value.

In the embodiment of the present invention, the measurement device may further include an illumination device (40) configured to irradiate a surface of the measurement object with visible light to form structured illumination for distance recognition. This configuration is even more effective from the viewpoint of achieving stable measurement regardless of the distance between the inspection apparatus and the measurement object.

In the embodiment of the present invention, the first optical system may irradiate a surface of the measurement object with the ultraviolet light by point irradiation, line irradiation, or surface irradiation. This configuration is more effective from the viewpoint of acquiring information on the spatial distribution of the intensity in the detected fluorescence and from the viewpoint of eliminating disturbance. In this case, the first optical system may scan and irradiate the surface of the measurement object with the ultraviolet light. This configuration is even more effective from the above viewpoint.

Furthermore, in the above case, the calculation unit may acquire time-series data of the light detected by the detector according to a detection value of the light detected by the detector, and acquire information of a spatial distribution of the light detected by the detector according to the time-series data. This configuration is still more effective from the viewpoint of acquiring information on the spatial distribution of the intensity in the detected fluorescence and from the viewpoint of eliminating disturbance.

In the embodiment of the present invention, the first optical system may irradiate the measurement object with the ultraviolet light by the structured illumination of the ultraviolet light, and the calculation unit may acquire the time-series data of the light according to the detection value of the light detected by the detector, and acquire the information of the spatial distribution of the light by taking a form of single pixel imaging in which an image is reconstructed by mathematically processing a pattern of structured illumination of the ultraviolet light and the time-series data. This configuration is even more effective from the viewpoint of realizing elimination of disturbance and shortening of measurement time.

In the embodiment of the present invention, the first optical system may irradiate the measurement object with ultraviolet light of which intensity is modulated, and the calculation unit may demodulate a detection value of the light detected by the detector by synchronous detection. This configuration is even more effective from the viewpoint of removing the disturbance and from the viewpoint of reducing the influence of the disturbance on the living body.

In the embodiment of the present invention, the first optical system may further include a light diffusion layer (for example, the light diffusion portion 15) that diffuses ultraviolet light. This configuration is even more effective from the viewpoint of homogenizing the distribution of the spatial intensity of the ultraviolet light.

In the embodiment of the present invention, the light diffusion layer may further include a fluorescence generating agent. This configuration is even more effective from the viewpoint of enabling the user to visually recognize the irradiation of the ultraviolet light.

In the embodiment of the present invention, the measurement device may further include a notification device (for example, the display device 60) for notifying a user of information on the aromatic amino acid and a residue thereof in the irradiated portion acquired by the calculation unit. This configuration is even more effective from the viewpoint of realizing appropriate or efficient measurement by the user.

The present invention is not limited to the above-described embodiments, and various modifications can be made within the scope indicated in the claims. Embodiments obtained by appropriately combining technical means disclosed in different embodiments are also included in the technical scope of the present invention.

What is claimed is:

1. An inspection apparatus comprising:
a first optical system configured to irradiate a measurement object with ultraviolet light;
a second optical system configured to detect, with a detector, one or more types of light selected from a group consisting of fluorescence of circularly polarized light having a wavelength of 200 nm or more and 400 nm or less, fluorescence of non-circularly polarized light, and reflected light of circularly polarized light emitted from an irradiated portion of the measurement object irradiated with the ultraviolet light; and
a calculation unit configured to acquire information on an aromatic amino acid and a residue thereof in the irradiated portion according to a detection value of light detected by the detector.

2. The inspection apparatus according to claim 1, wherein the calculation unit calculates one or more characteristics selected from a group consisting of absorption of circularly polarized light having a wavelength of 200 nm or more and 320 nm or less derived from a secondary structure of a protein, absorption of circularly polarized light having a wavelength of 240 nm or more and 320 nm or less derived from a side chain of an amino acid, and a difference in emission intensity of left- and right-handed circularly polarized light in these circularly polarized light according to detection values of fluorescence of circularly polarized light and reflected light of circularly polarized light detected by the detector, and acquires information on the aromatic amino acid and a residue thereof in the irradiated portion.

3. The inspection apparatus according to claim 1, further comprising a distance measurement device configured to measuring a distance to the measurement object by an ultrasonic wave or an electromagnetic wave,
wherein the calculation unit corrects a detection value of light detected by the detector according to a measurement value of the distance by the distance measurement device.

4. The inspection apparatus according to claim 1, further comprising an illumination device configured to irradiate a surface of the measurement object with visible light to form structured illumination for distance confirmation.

5. The inspection apparatus according to claim 1, wherein the first optical system irradiates a surface of the measurement object with the ultraviolet light by point irradiation, line irradiation, or surface irradiation.

6. The inspection apparatus according to claim 5, wherein the first optical system scans and irradiates the surface of the measurement object with the ultraviolet light.

7. The inspection apparatus according to claim 6, wherein the calculation unit acquires time-series data of the light detected by the detector according to a detection value of the light detected by the detector, and acquires information of a spatial distribution of the light detected by the detector according to the time-series data.

8. The inspection apparatus according claim 1, wherein
the first optical system irradiates the measurement object with ultraviolet light by structured illumination of ultraviolet light, and
the calculation unit acquires time-series data of the light detected by the detector according to a detection value of the light detected by the detector, and acquires information of a spatial distribution of the light detected by the detector by taking a form of single pixel imaging in which an image is reconstructed by mathematically processing a pattern of structured illumination of the ultraviolet light and the time-series data.

9. The inspection apparatus according to claim 1, wherein
the first optical system irradiates the measurement object with ultraviolet light of which intensity is modulated, and
the calculation unit demodulates a detection value of the light detected by the detector by synchronous detection.

10. The inspection apparatus according to claim 1, wherein the first optical system further includes a light diffusion layer that diffuses ultraviolet light.

11. The inspection apparatus according to claim 10, wherein the light diffusion layer further includes a fluorescence generating agent.

12. The inspection apparatus according to claim 1, further comprising a notification device configured to notify a user of information on the aromatic amino acid and a residue thereof in the irradiated portion acquired by the calculation unit.

13. An information processing system comprising:
an irradiation control unit configured to irradiate a measurement object with ultraviolet light;
a detection control unit configured to detect, with a detector, one or more types of light selected from a group consisting of fluorescence of circularly polarized light having a wavelength of 200 nm or more and 400 nm or less, fluorescence of non-circularly polarized light, and reflected light of circularly polarized light emitted from an irradiated portion of the measurement object irradiated with ultraviolet light;
a calculation unit configured to acquire information on an aromatic amino acid and a residue thereof in the irradiated portion according to a detection value of light detected by the detector; and
a notification control unit configured to notify a user of information on the aromatic amino acid and a residue thereof in the irradiated portion acquired by the calculation unit.
